(19) United States
(12) Patent Application Publication
(10) Pub. No.: US 2007/0286156 A1
(43) Pub. Date: Dec. 13, 2007

(54) Utilizing guard band between FDD and TDD wireless systems

(75) Inventors: Eamonn F. Gormley, Redmond, WA (US); Chad A. Pralle, Montreal (CA)

Correspondence Address: HOLLAND & KNIGHT LLP, 10 ST. JAMES AVENUE, 11th Floor, BOSTON, MA, 02116-3889, US

(73) Assignee: SR Telecom Inc, Montreal (CA)

(21) Appl. No.: 11/810,551

(22) Filed: Jun. 6, 2007

Related U.S. Application Data
(60) Provisional application No. 60/811,208, filed on Jun. 6, 2006.

(51) Int. Cl. H04J 3/06

(52) U.S. Cl. 370/350

(57) ABSTRACT

A wireless system and method includes a frequency division duplex (FDD) system configured to provide at least a first FDD channel operating within a first frequency band. A time division duplex (TDD) system is configured to provide at least a first TDD channel operating within a second frequency band. The first frequency band and the second frequency band are separated by a third frequency band, and a half-duplex frequency division duplex (H-FDD) system is configured to provide at least a first H-FDD channel operating within the third frequency band. A transmission of the first H-FDD channel may be synchronized with one of an uplink transmission and a downlink transmission of the first TDD channel.

### CROSS-REFERENCE TO RELATED APPLICATIONS

This application claims the benefit of U.S. provisional patent application Ser. No. 60/811,208, filed on Jun. 6, 2006, the entire disclosure of which is incorporated by reference.

### TECHNICAL FIELD

This disclosure relates to wireless networks, and more particularly to utilizing a guard band between frequency division duplex (FDD) and time division duplex (TDD) wireless systems.

### BACKGROUND

There are two primary duplexing schemes that are used in wireless communications systems, i.e., Frequency Division Duplexing (FDD) and Time Division Duplexing (TDD). In a FDD scheme, two radios in a system communicate with each other at the same time by transmitting and receiving on different frequencies. In a TDD scheme, two radios in a system transmit and receive on the same frequencies at different times.

Another duplexing scheme is known as Half-Duplex Frequency Division Duplexing (H-FDD). H-FDD is similar to FDD in that a radio using H-FDD duplexing uses different frequencies for transmission and reception. H-FDD is similar to TDD in that a radio using H-FDD duplexing transmits and receives at different times. A radio nominally designed to operate using FDD can also operate in H-FDD mode by ensuring that it never transmits and receives RF signals at the same time. It may also be possible for a radio nominally designed to operate using TDD to operate as a H-FDD radio by configuring the TDD radio to transmit and receive on different frequencies.

The wireless industry is rapidly moving to TDD wireless systems for broadband wireless networks. However, FDD wireless systems are the historically prevalent wireless system. While deployments in clear spectrum do not present problems with either one of these wireless systems, many spectrum allocations do not specify TDD or FDD wireless systems. Thus, there may be situations where operators wish to deploy TDD and FDD wireless systems in the same geographical area, including co-located equipment, using frequency bands that are close to each other.

TDD and FDD wireless systems that are deployed in the same geographical area and that operate in adjacent frequency bands can cause RF interference with one another. To make these two methodologies coexist, the TDD and FDD wireless systems must be separated by distance or by frequency. Separating the two systems by distance may not be feasible simply because the wireless network needs to operate where the customers are located. Therefore, separating the TDD and FDD wireless systems by frequency is typically the most common method for allowing coexistence of the two systems. Separation by frequency involves the allocation of “guard bands,” which are “RF quiet spaces,” between the TDD and FDD wireless systems. Expensive and complicated filtering techniques and directional antennas have typically been used to minimize the size of the guard bands, but the guard bands are still necessary for the coexistence of TDD and FDD wireless systems.

While the guard bands provide the necessary frequency separation to allow coexistence of TDD and FDD wireless systems, guard bands result in unused portions of very valuable spectrum. The present disclosure may allow an operator to make use of this otherwise unused spectrum required for guard bands between TDD and FDD wireless systems.

### SUMMARY

According to one implementation, a wireless network may include a frequency division duplex (FDD) system that may be configured to provide at least a first FDD channel operating within a first frequency band. A time division duplex (TDD) system may be configured to provide at least a first TDD channel operating within a second frequency band. The first frequency band and the second frequency band may be separated by a third frequency band. The wireless network may also include a half-duplex frequency division duplex (H-FDD) system that may be configured to provide at least a first H-FDD channel operating within the third frequency band. A transmission of the first H-FDD channel may be synchronized with one of an uplink transmission or a downlink transmission of the TDD channel.

One or more of the following features may also be included. The FDD system may further be configured to provide at least a second FDD channel operating within a fourth frequency band, which may be separated from the second frequency band by a fifth frequency band. The H-FDD system may further be configured to provide at least a second H-FDD channel operating within the fifth frequency band. Furthermore, the first FDD channel may include a wireless uplink channel and the second FDD channel may include a wireless downlink channel. The first H-FDD channel may include a wireless uplink channel. In an embodiment in which the first H-FDD channel is a wireless uplink channel, an uplink transmission of the first TDD channel may be synchronized with a transmission of the first H-FDD channel. The first H-FDD channel may include a wireless downlink channel. In an embodiment in which the first H-FDD channel is a wireless downlink channel, a downlink transmission of the first TDD channel may be synchronized with a transmission of the first H-FDD channel.

According to another implementation, a method for sharing a frequency spectrum between multiple collocated wireless systems may include providing at least a first frequency division duplex (FDD) channel operating within a first frequency band, and providing at least a first time division duplex (TDD) channel operating within a second frequency band. The first frequency band and the second frequency band may be separated by a third frequency band. At least a first half-duplex frequency division duplex (H-FDD) channel may be provided operating within the third frequency band. The first FDD channel, the first TDD channel, and the first H-FDD channel may be collocated with one another. A transmission of the first H-FDD channel being synchronized with one of an uplink transmission or a downlink transmission of the TDD channel.

The method may include one or more of the following features. A second FDD channel may be provided operating within a fourth frequency band, in which the fourth frequency band may be separated from the second frequency band by a fifth frequency band. The method may also include providing a second H-FDD channel operating within the fifth frequency band. The first FDD channel may include an FDD wireless uplink channel and the second FDD channel may include a FDD wireless downlink channel. Furthermore, the first H-FDD channel may include an H-FDD wireless uplink channel or the first H-FDD channel may include an H-FDD wireless downlink channel. In an embodiment in which the first H-FDD channel is a wireless uplink channel, the method may include synchronizing the uplink transmission of the first TDD channel and the transmission of the first H-FDD channel. Correspondingly, in an embodiment in which the first H-FDD channel is a wireless downlink channel, the method may include synchronizing the downlink transmission of the TDD channel and the transmission of the first H-FDD channel.

According to yet another implementation, a method for implementing a time division duplex (TDD) wireless system in a wireless network including a frequency division duplex (FDD) wireless system may include replacing a first frequency band of a the FDD wireless system with at least a first TDD wireless channel. This may include leaving a first and a second guard band separating the first TDD wireless channel and at least a first and a second adjacent FDD wireless channel. The method may also include deploying a half-duplex frequency division duplex (H-FDD) system in the first and second guard bands.

One or more of the following features may also be included. Replacing the first frequency band of the FDD wireless system may include replacing the first frequency band with at least one H-FDD wireless channel of the H-FDD system, and replacing at least a portion of the first H-FDD wireless channel with at least the first TDD wireless channel. The H-FDD system may be deployed in the first and second guard bands. The method may further include expanding the TDD wireless channel to eliminate the first and second FDD wireless channels.

The first FDD wireless channel may include an uplink channel, and the H-FDD system deployed in the first guard band may include an uplink channel adjacent to the first FDD wireless channel. Correspondingly, the second FDD wireless channel may include a downlink channel, and the H-FDD system deployed in the second guard band may include a downlink channel adjacent to the second FDD wireless channel.

The H-FDD system may include an H-FDD uplink channel. Transmission of the H-FDD uplink channel may be synchronized with an uplink transmission of the first TDD wireless channel. Similarly, the H-FDD system may include an H-FDD downlink channel. Transmission of the H-FDD downlink channel may be synchronized with a downlink transmission of the first TDD wireless channel.

According to another implementation, a wireless system may include a half-duplex frequency division duplex (H-FDD) system configured to provide at least a first H-FDD channel. A transmission of the first H-FDD channel may be configured to be synchronized with one of an uplink transmission or a downlink transmission of a TDD channel of a TDD wireless system.

The wireless system may include one or more of the following features. The first H-FDD channel may be an uplink channel, and the transmission of the first H-FDD channel may be configured to be synchronized with the uplink transmission of the TDD wireless system. The first H-FDD channel may be a downlink channel, and the transmission of the first H-FDD channel is configured to be synchronized with the downlink transmission of the TDD wireless system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagram of a wireless network including FDD, TDD, and H-FDD wireless systems.

FIG. 2 diagrammatically shows spectrum utilization in a wireless network including FDD, TDD and H-FDD wireless systems.

FIG. 3 diagrammatically shows spectrum utilization in a wireless network including FDD, TDD, and H-FDD wireless systems.

FIG. 4 is a flow chart of a method for transitioning a wireless network from an FDD wireless system to a TDD wireless system.

FIG. 5 diagrammatically depicts spectrum utilization in a wireless network including an FDD wireless system.

FIG. 6 diagrammatically depicts spectrum utilization including an H-FDD wireless system build-out in a wireless network including an FDD wireless system.

FIG. 7 diagrammatically depicts spectrum utilization including a TDD wireless system build-out in a wireless network including an FDD wireless system.

FIG. 8 diagrammatically depicts spectrum utilization in a wireless network converted to a TDD wireless system.

### DETAILED DESCRIPTION

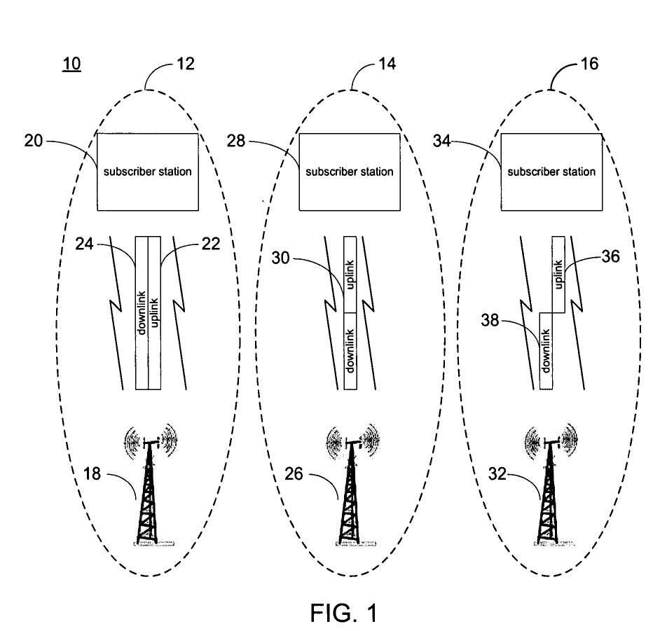

Referring to FIG. 1, wireless network 10 is shown that may include FDD wireless system 12, TDD wireless system 14, and half-duplex frequency division duplex (H-FDD) wireless system 16. FDD wireless system 12, TDD wireless system 14 and H-FDD wireless system 16 may all be deployed and operated by a single network operator, or may be deployed and operated by multiple network operators. As will be discussed in greater detail below, wireless network 10 may utilize guard bands between spectrum allocated to FDD wireless system 12 and TDD wireless system 14, which may provide the necessary frequency separation for the coexistence of FDD wireless system 12 and TDD wireless system 14. Additionally, wireless network 10 may include H-FDD wireless system 16 operating in the guard bands between FDD wireless system 12 and TDD wireless system 14. H-FDD wireless system 16 may include radios that can also operate as FDD or TDD radios. The radios of H-FDD wireless system 16 may be configured to operate as H-FDD radios (i.e., in half-duplex frequency division duplex mode).

Operation of H-FDD wireless system 16 in the guard bands between FDD wireless system 12 and TDD wireless system 14 may provide improved spectrum utilization, by reducing or eliminating unused frequency bands in the spectrum used by wireless network 10. In order for the H-FDD wireless system 16 to operate in the guard bands between FDD wireless system 12 and TDD wireless system 14 without interference, the timing of the transmissions of the H-FDD wireless system 16 can be synchronized with the timing of TDD wireless system 12 so that uplink transmissions on H-FDD wireless system 16 may occur within the same time interval as uplink transmissions on TDD wireless system 12 and downlink transmissions on H-FDD wireless system 16 may occur within the same time interval as downlink transmissions on TDD wireless system 12. That is, synchronized timing of TDD wireless system 12 and H-FDD wireless system 16 may avoid uplink transmission by one system during downlink transmission by the other system, within adjacent frequency bands. Uplink transmissions refer to RF signals transmitted by the subscriber stations and received by the base station, while downlink transmissions refer to RF signals transmitted by the base station and received by the subscriber stations.

FDD wireless system 12 may include one or more FDD base stations (e.g., FDD base station 18) that may each communicate with one or more FDD subscriber stations (e.g., FDD subscriber station 20). For clarity of illustration, only a single base station and subscriber station are shown. FDD base station 18 and FDD subscriber station 20 may communicate with each other, by making use of different frequency bands for the uplink and downlink transmissions. For example, FDD base station 18 and FDD subscriber station 20 may communicate with each other using FDD uplink channel 22 transmitted within a first frequency band, and FDD downlink channel 24 transmitted within a second frequency band. FDD uplink channel 22 and FDD downlink channel 24 may provide simultaneous uplink and downlink communication (i.e., FDD base station 18 and FDD subscriber station 20 can both transmit at the same time), and may each transmit within distinct frequency bands. FDD wireless system 12 may include, for example, a wireless broadband system. One example of a wireless broadband system is standardized by IEEE 802.16 and is known as WiMAX.

TDD wireless system 14 may include one or more TDD base stations (e.g., TDD base station 26) that may each communicate with one or more TDD subscriber stations (e.g., TDD subscriber station 28) using TDD uplink/downlink channel 30 that may provide duplex communication over a single channel operating within a single frequency band. For clarity of illustration only a single TDD base station and subscriber station are shown. TDD uplink/downlink channel 30 may provide both downlink and uplink communications using a time-wise division of TDD uplink/downlink channel 30. TDD wireless system 14 may also include, for example, a wireless broadband system.

H-FDD wireless system 16 may include one or more H-FDD base stations (e.g., H-FDD base station 32) that may each communicate with one or more H-FDD subscriber stations (e.g., H-FDD subscriber station 34) using H-FDD uplink channel 36 and H-FDD downlink channel 38. For clarity, only a single H-FDD base station and subscriber station are shown. H-FDD uplink channel 36 and H-FDD downlink channel 38 may each operate within distinct frequency bands, and may also use time-wise separation between downlink and uplink transmissions (i.e., the H-FDD base stations and subscriber stations may either transmit or receive at any given time, but may not do both simultaneously). H-FDD wireless system 16 may, therefore, use both frequency separation and time separation between uplink and downlink transmissions. Since the H-FDD wireless system 16 uses different frequencies for H-FDD uplink channel 36 and H-FDD downlink channel 38, as well as time separation between uplink and downlink transmissions, the spectrum efficiency of H-FDD wireless system 16 may be approximately 50% compared to FDD or TDD wireless systems 12, 14. H-FDD wireless system 16 may also be, for example, a wireless broadband system.

FDD wireless system 12, TDD wireless system 14, and H-FDD wireless system 16 may be located in a common geographical region such that each base station 18, 26, 32 and/or subscriber station 20, 28, 34 is within range of at least one other base station 18, 26, 32 and/or subscriber station 20, 28, 34. Base stations 18, 26, 32 may include separately located base stations, e.g., having separate antenna masts and separate physical locations. Alternatively, base stations 18, 26, 32 may be co-located and may share the same antenna mast. Similarly, subscriber stations 20, 28, 34 may include customer premises equipment installed at different locations. Alternatively, one or more subscriber station 20, 28, 34 may be installed at a single location, e.g., providing the location with diverse services via the FDD wireless system 12, TDD wireless system 14 and/or H-FDD wireless system 16.

If not designed correctly, one or more of the multiple wireless systems (e.g., FDD wireless system 12, TDD wireless system 14, and H-FDD wireless system 16) in wireless network 10 may be subject to RF interference caused by transmissions in any of the other wireless systems (e.g., FDD wireless system 12, TDD wireless system 14, H-FDD wireless system 16) in network 10. The interference between the various wireless systems may be caused when out of band RF energy from one or more transmitters using one duplexing scheme leaks into one or more receivers using another duplexing scheme. Interference may be especially prevalent in a system including an FDD system and a TDD system operating within adjacent frequency bands because a TDD system transmits and receives on the same frequency band. In order to prevent, or at least reduce, interference between a TDD wireless system and an FDD wireless system, a guard band (i.e., a frequency band that is “RF quiet” and not used for transmitting or receiving by either the TDD system or the FDD system) may be maintained between the TDD and FDD wireless systems operating within adjacent frequency bands.

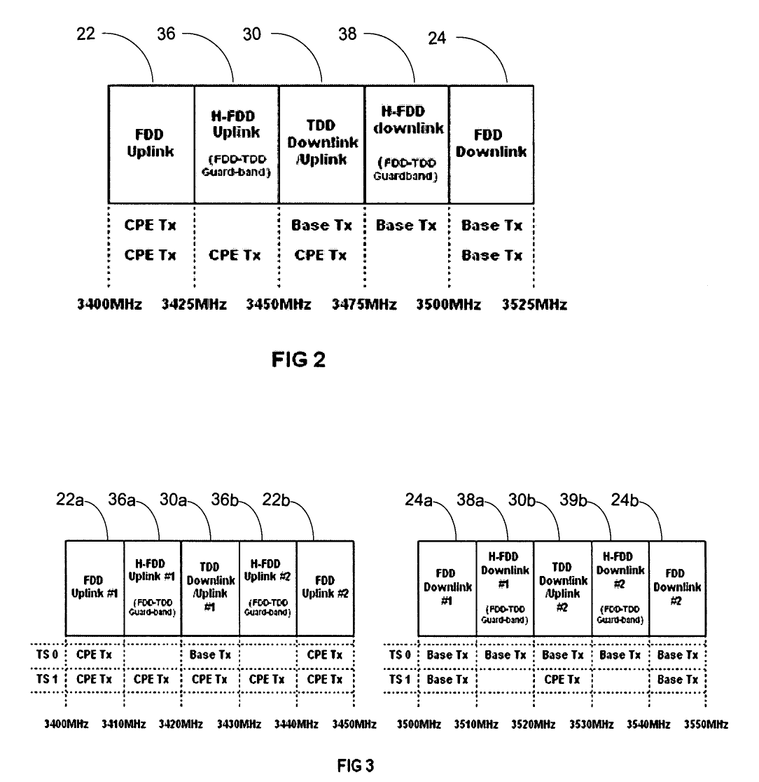

Referring also to FIG. 2, wireless network 10 may provide frequency separation between TDD uplink/downlink channel 30 and each of FDD uplink channel 22 and FDD downlink channel 24. The frequency separation between TDD uplink/downlink channel 30 and FDD uplink channel 22 and FDD downlink channel 24 may reduce, or eliminate, interference between TDD wireless system 14 and FDD wireless system 12. FDD uplink channel 22 may operate within a first frequency band and TDD uplink/downlink channel 30 may operate within a second frequency band. H-FDD uplink channel 36 may operate within a third frequency band separating FDD uplink channel 22 and TDD uplink/downlink channel 30 (i.e., a guard band). In a similar manner, FDD downlink channel 24 may operate within a fourth frequency band separated from TDD uplink/downlink channel 30 by a fifth frequency band within which H-FDD downlink channel 38 operates (i.e., another guard band).

Continuing with the example shown in FIG. 2, FDD uplink channel 22 may be separated from TDD uplink/downlink channel 30 by a 25 MHz guard band. H-FDD uplink channel 36 may operate within the guard band separating FDD uplink channel 22 and TDD uplink/downlink channel 30. Similarly, FDD downlink channel 24 may also be separated from TDD uplink/downlink channel 30 by a 25 MHz guard band. H-FDD downlink channel 38 may operate within the guard band separating FDD downlink channel 24 and TDD uplink/downlink channel 30. While 25 MHz frequency separation between TDD uplink/downlink channel 30 and respective FDD uplink channel 22 and downlink channel 24 is depicted in FIG. 2, the frequency separation may be varied according to a specific application. Generally, the frequency separation may be large enough to minimize, or prevent, interference between FDD wireless system 12 and TDD wireless system 14.

The number of H-FDD channel pairs (i.e., H-FDD uplink channel 36 and H-FDD downlink channel 38, together providing duplex communication) that may operate in the guard bands may be based, at least in part, on the bandwidth of the guard band and the minimum bandwidth for an H-FDD channel. Continuing with the example shown in FIG. 2, for a 25 MHz guard band and a minimum H-FDD channel bandwidth of 25 MHz, only a single H-FDD uplink channel 36 and H-FDD downlink channel 38 may be included in the respective guard bands between TDD uplink/downlink channel 30 and FDD uplink and downlink channels 22, 24. In an embodiment in which the minimum H-FDD channel bandwidth is 5 MHz, however, five H-FDD channels may operate within each 25 MHz guard band, giving a total of five duplex H-FDD links (i.e., H-FDD uplink/downlink channel pairs).

The guard band bandwidths and channel bandwidths described with reference to the preceding examples have been provided for the purposed of illustration only. Guard band bandwidth and channel bandwidth may be selected based upon, for example, the requirements and attributes of the various wireless systems, quality of service requirements and regulatory requirements. As such, various additional/alternative guard band and channel bandwidths may suitably be used in connection with a wireless network.

Interference between FDD uplink channel 22 and H-FDD uplink channel 36 may be prevented, or reduced, based, at least in part, through common frequency allocation by the wireless network operators. That is, H-FDD uplink channel 36 may operate within a frequency band adjacent to FDD uplink channel 22. As such, FDD subscriber station 20 and H-FDD subscriber station 34 both may be transmitting on adjacent frequency bands. Therefore, FDD subscriber station 20 is not broadcasting while H-FDD subscriber station 34 is receiving within an adjacent frequency band, and vice versa. Allocation of frequencies for FDD downlink channel 24 and H-FDD downlink channel 38 may also be made to eliminate, or reduce, interference. H-FDD downlink channel 38 may operate within a frequency band adjacent to the frequency band within which FDD downlink channel 24 operates. As such, FDD base station 18 is not transmitting within a frequency band adjacent to a frequency band within which H-FDD base station 32 is receiving, and vice versa.

Interference between TDD uplink/downlink channel 30 and H-FDD uplink channel 36 and H-FDD downlink channel 38 may be reduced, or prevented, by synchronizing downlink and uplink transmissions of TDD wireless system 14 and H-FDD wireless system 16. For example, TDD base station 26 and H-FDD base station 32 may transmit during the same time interval. As such, TDD base station 26 may not be receiving while neighboring (e.g., operating within an adjacent frequency band and/or located in a common geographic region) H-FDD base station 32 is transmitting, and TDD base station 26 may not be transmitting while neighboring H-FDD base station 32 is receiving. Similarly, TDD subscriber station 28 and H-FDD subscriber station 34 may also transmit in the same time interval. As with the base stations, TDD subscriber station 28 may not be receiving while neighboring H-FDD subscriber station 34 is transmitting, and vice versa.

Referring also to FIG. 3, TDD wireless system 14 may be deployed in the middle of FDD wireless system 12 uplink spectrum allocation and in the middle of FDD wireless system downlink spectrum allocation. That is, first TDD uplink/downlink channel 30a may operate within a frequency band in between first FDD uplink channel 22a and second FDD uplink channel 22b. Second TDD uplink/downlink channel 30b may operate within a frequency band in between first FDD downlink channel 24a and second FDD downlink channel 24b. H-FDD wireless system 16 may operate within guard bands between first TDD uplink/downlink channel 30a and first and second FDD uplink channels 22a, 22b. Similarly, H-FDD wireless system 16 may operate within the guard bands between second TDD downlink/uplink channel 30b and first and second FDD downlink channels 24a, 24b.

In the embodiment depicted in FIG. 3, each H-FDD channel 36a, 36b, 38a, 38b may have a 10 MHz bandwidth. That is, first and second H-FDD uplink channel 36a, 36b may operate within each 10 MHz guard band separating first and second FDD uplink channels 22a, 22b and first TDD uplink/downlink channel 30a. In a corresponding manner, first and second H-FDD downlink channels 38a, 38b may operate within each 10 MHz guard band separating first and second FDD downlink channels 24a, 24b and second TDD uplink/downlink channel 30b.

The frequency allocation of first and second H-FDD uplink channels 36a, 36b may be within the frequency allocation for first and second FDD uplink channels 22a, 22b. The frequency allocation of first and second H-FDD downlink channels 38a, 38b may be within the frequency allocation for first and second FDD downlink channels 24a, 24b. As discussed above, the common frequency allocation of FDD uplink channels 22a, 22b and H-FDD uplink channels 36a, 36b and of FDD downlink channels 24a, 24b and H-FDD downlink channels 38a, 38b may reduce, or prevent, interference between FDD wireless system 12 and H-FDD wireless system 16.

The transmission timing of first and second H-FDD uplink channels 36a, 36b may be synchronized with the uplink transmission timing of first TDD uplink/downlink channel 30a, thereby reducing, or preventing, interference between first and second H-FDD uplink channels 36a, 36 and first TDD uplink/downlink channel 30a operating within an adjacent frequency band. Similarly, the transmission timing of first and second H-FDD downlink channels 38a, 38b may be synchronized with downlink transmission timing of second TDD uplink/downlink channel 30b, thereby reducing, or preventing, interference between first and second H-FDD downlink channels 38a, 38b and second TDD uplink/downlink channel 30b operating within an adjacent frequency band.

In the embodiment of FIG. 3, a 10 MHz guard band between TDD uplink/downlink channels 30a, 30b and FDD uplink and downlink channels 22a, 22b, 24a, 24b may be sufficient for coexistence of TDD wireless system 14 and FDD wireless system 12. The bandwidth of the guard bands may be reduced, e.g., using RF filters providing better out of band rejection.

As discussed above, H-FDD wireless system 16 may have a lower spectrum efficiency than FDD wireless system 12 and TDD wireless system 14 (i.e., because H-FDD wireless system 16 requires two frequency bands for duplex communication, but only transmits or receives at a given time). In the embodiment of FIG. 3, the 10 MHz guard bands between FDD channels 22a, 22b, 24a, 24b and TDD channels 30a, 30 would result in 40 MHz of unused spectrum. H-FDD wireless system 16 having half the spectrum efficiency of FDD wireless system 12 and TDD wireless system 14 may still allow 20 MHz (i.e., half of the unused 40 MHz guard band spectrum) of the spectrum to be used. Therefore, even with a lower spectrum efficiency, utilizing H-FDD wireless system 16 in the guard bands may enable revenue to be collected by the operator of wireless network 10 for the previously unused guard band spectrum.

H-FDD wireless system 16 operating within frequency bands between FDD wireless system 12 and TDD wireless system 14 may be used to facilitate a staged build out of TDD wireless system 12 in a preexisting FDD wireless and/or a staged conversion of a wireless network from an FDD wireless system 12 to an at least predominantly TDD 14 wireless network.

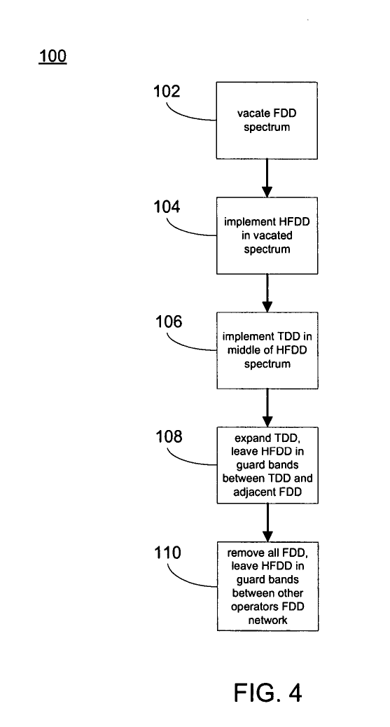

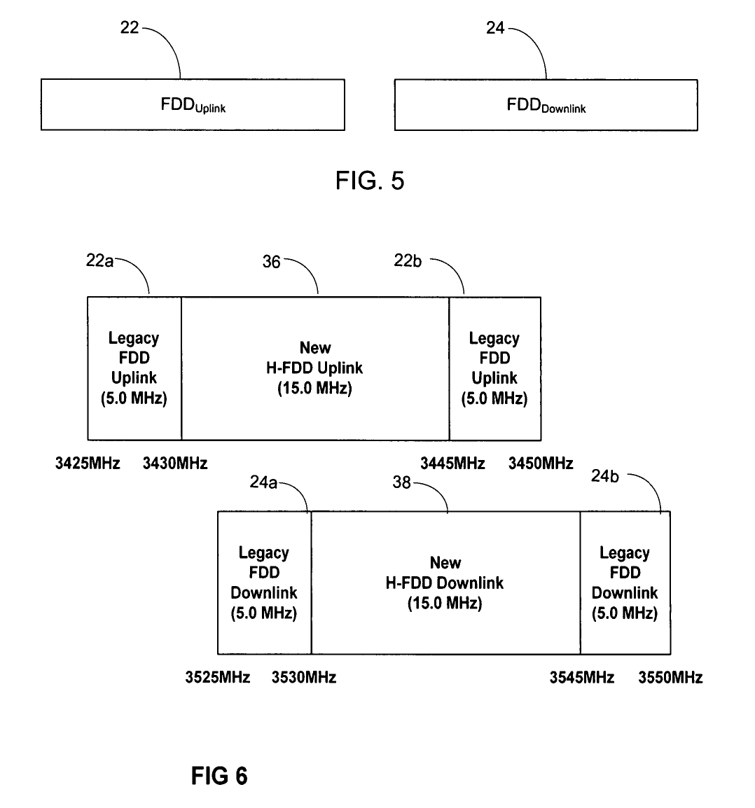

Referring to FIG. 4, there is shown a method 100 for transitioning wireless network 10 including an existing FDD wireless system 12 to include TDD wireless system 14, which may be, for example, a WiMAX network complying with IEEE 802.16e. Wireless network 10 may include spectrum occupied by FDD wireless system 12, including one or more FDD channels. For ease of explanation, only one FDD uplink channel 22 and one FDD downlink channel 24 are shown in FIG. 5, although FDD uplink and downlink spectrum may each include multiple FDD channels. The spectrum indicated by FDD uplink channel 22 and FDD downlink channel 24 may each include one or more uplink and downlink channels.

Method 100 may allow for transition from FDD wireless system 12 to TDD wireless system 14 in stages, e.g., allowing FDD wireless system 12 to be phased out over time and TDD wireless system 14 to be built out over time. Alternatively, build out of TDD wireless system 14 may take place in parallel with vacating FDD spectrum. That is, rather than a staged build out of TDD wireless system 14, TDD wireless system 14 may be deployed and at least a portion of the FDD wireless system 12 may be taken out of service at the same time.

Method 100 for staged build out of TDD wireless network 14 may include vacating 102 a portion of the FDD spectrum, e.g., clearing a portion of the spectrum including FDD uplink channel 22 and a portion of the spectrum including FDD downlink channel 24. H-FDD wireless system 16 may be implemented 104 in the vacated FDD spectrum. For example one or more H-FDD uplink and downlink channels, e.g., H-FDD uplink and downlink channels 36, 38, may be implemented in the vacated FDD spectrum. H-FDD wireless system 16 may include a WiMAX wireless system, which may comply with IEEE 802.16e. The channel bandwidth chosen for the H-FDD uplink and downlink channels 36, 38 may be small enough to enable sufficient channels for network planning purposes, but large enough to offer the services that the operator requires in its network.

H-FDD uplink channel 36 may be implemented within the vacated FDD uplink spectrum, e.g., with one or more FDD uplink channels 22a, 22b operating within the spectrum on either side of H-FDD uplink channel 36, and one or more FDD downlink channels 24a, 24b operating within the spectrum on either side of H-FDD downlink channel 38. Alternatively/additionally, one or both of H-FDD uplink and downlink channels 36, 38 may operate within the spectrum on either edge of the FDD uplink and downlink spectrum. In such an embodiment, H-FDD uplink and/or downlink channel may operate within a frequency band that is only adjacent to one FDD channel.

TDD wireless system 14 may be implemented 106 in a frequency band within the spectrum occupied by H-FDD wireless system 16. H-FDD wireless system 16 may be provided using equipment capable of operating in either H-FDD or TDD mode, thereby facilitating implementation of TDD wireless system 14 with spectrum occupied by H-FDD wireless system. As such, guard bands may be maintained between TDD uplink/downlink channels 30a, 30b and FDD uplink and downlink channels 22a, 22b, 24a, 24b. One or more H-FDD uplink and downlink channels, e.g., H-FDD channels 36a, 36b, 38a, 38b, may operate within the frequency band of the guard bands.

If sufficient spectrum of FDD wireless system 12 can be initially vacated, TDD wireless system 14 may be deployed within the vacated FDD wireless system 12 spectrum, along with H-FDD wireless system 16 operating in the guard bands between FDD and TDD wireless systems 12, 14 in a single process. In such an embodiment, it may not be necessary to sequentially deploy H-FDD within spectrum vacated by FDD wireless system 12, and then deploy TDD wireless system 14 within spectrum of H-FDD wireless system 16.

Deployment of TDD wireless system 14 may include the implementation of additional filtering in FDD wireless system 12, e.g., implemented in connection with FDD base station radios and/or FDD subscriber station radios. Filters may be added to the transmit chain in the case where TDD wireless system 14 transmit and receive frequency is adjacent to the FDD downlink frequency. Additionally, filters may also be added to the FDD wireless system 12 receivers if TDD wireless system 14 transmit and receive frequency is adjacent to FDD wireless system 12 uplink frequency.

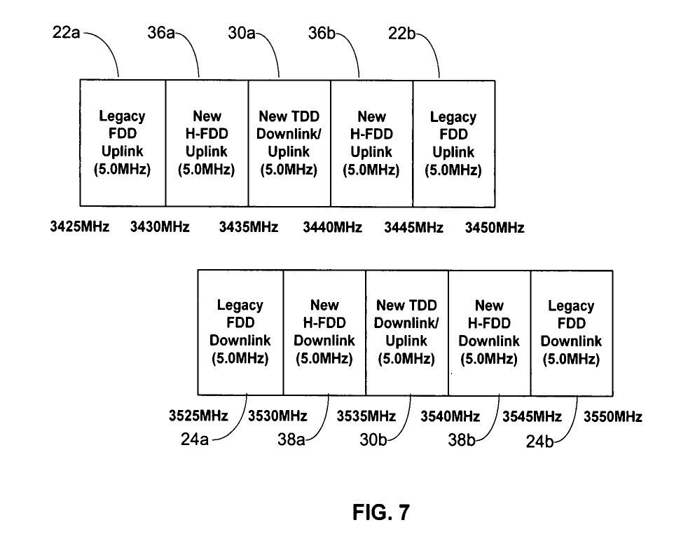

As described above with reference to wireless network 10 including FDD wireless system 12, TDD wireless system 14, and H-FDD wireless system 16, various spectrum usage scenarios are possible based upon, at least in part, the guard band bandwidth and channel bandwidth of the various wireless systems 12, 14, 16. For example, referring also to FIG. 7, TDD uplink/downlink channels 30a, 30b may each have a 5.00 MHz bandwidth, with 5.00 MHz frequency separation (guard bands) between TDD uplink/downlink channels 30a, 30b and FDD uplink and downlink channels 22a, 22b, 24a, 24b. H-FDD uplink and downlink channels 36a, 36b, 38a, 38b may, accordingly, have a 5.00 MHz bandwidth. Other bandwidths may suitably be employed in connection with TDD uplink/downlink channels 30a, 30b and H-FDD uplink and downlink channels 36a, 36b, 38a, 38b. Additionally, bandwidth of TDD uplink/downlink channel 30a, 30b may differ from H-FDD uplink and downlink channel 36a, 36b, 38a, 38b bandwidth. Further, spectrum allocation of TDD wireless system 12 may differ from the bandwidth of the guard bands occupied by H-FDD uplink and downlink channels 36a, 36b, 38a, 38b.

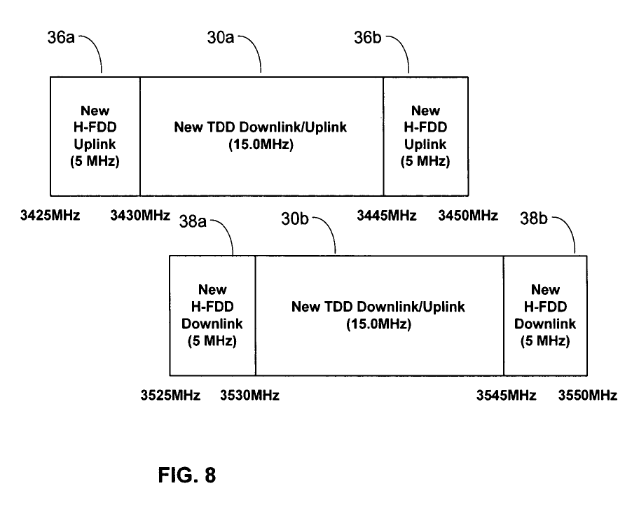

Method 100 may also include expanding 108 TDD wireless system 14 to utilize a greater portion of the available spectrum. Referring also to FIG. 8, expanding TDD wireless system 14 may include removing 110 legacy FDD wireless system 12. It may be desirable and/or necessary to maintain frequency separation between TDD wireless system 14 and adjacent networks (not shown), e.g., that may be maintained by other network operators. As such, H-FDD wireless system 16 may be maintained, e.g., providing H-FDD uplink and downlink channels 36a, 36b, 38a, 38b in the guard bands separating TDD wireless system 14 from wireless networks maintained by other wireless network operators, which may be operating in portions of the spectrum adjacent to wireless network 10. However, if wireless networks operating in adjacent portions of the spectrum utilize TDD wireless systems, a minimal guard band may be sufficient to reduce, or prevent, interference.

Method 100 may allow wireless network 10 to be migrated to TDD and H-FDD wireless systems 14, 16, e.g., providing WiMAX services. As shown in FIG. 8, TDD and/or H-FDD wireless systems 14, 16 may be deployed in the 25 MHz+25 MHz available spectrum. This may allow the revenues that can be generated from the available spectrum to be maximized.

In another embodiment, a wireless system may include TDD wireless system 14 having H-FDD wireless system 16 deployed in frequency bands (e.g., guard bands) on either side of TDD wireless system 14. As shown in FIG. 8, one or more H-FDD uplink and downlink channels 36, 38 may be deployed within frequency bands (guard bands) separating one or more TDD uplink/downlink channels 30 from adjacent FDD and/or TDD systems, e.g., which may be operated by the same, or another, operator.

It is to be understood that the foregoing description is intended to illustrate and not to limit the scope of the invention, which is defined by the scope of the appended claims. Other embodiments are within the scope of the following claims.

What is claimed is:

1. A wireless network comprising:
a frequency division duplex (FDD) system configured to provide at least a first FDD channel operating within a first frequency band;
a time division duplex (TDD) system configured to provide at least a first TDD channel operating within a second frequency band, the first frequency band and the second frequency band being separated by a third frequency band; and
a half-duplex frequency division duplex (H-FDD) system configured to provide at least a first H-FDD channel operating within the third frequency band, a transmission of the first H-FDD channel being synchronized with one of an uplink transmission or a downlink transmission of the TDD channel.

2. The wireless network of claim 1, wherein the FDD system is further configured to provide at least a second FDD channel operating within a fourth frequency band separated from the second frequency band by a fifth frequency band, and wherein the H-FDD system is further configured to provide at least a second H-FDD channel operating within the fifth frequency band.

3. The wireless network of claim 2, wherein the first FDD channel includes a wireless uplink channel and the second FDD channel includes a wireless downlink channel.

4. The wireless network of claim 2, wherein the first H-FDD channel includes a wireless uplink channel and the second H-FDD channel includes a wireless downlink channel.

5. The wireless network of claim 1, wherein the first H-FDD channel includes a wireless uplink channel, and the uplink transmission of the first TDD channel is synchronized with the transmission of the first H-FDD channel.

6. The wireless network of claim 1, wherein the first H-FDD channel includes a wireless downlink channel, and the downlink transmission of the first TDD channel is synchronized with the transmission of the first H-FDD channel.

7. A method for sharing a frequency spectrum between multiple collocated wireless systems comprising:
providing at least a first frequency division duplex (FDD) channel operating within a first frequency band;
providing at least a first time division duplex (TDD) channel operating within a second frequency band, the first frequency band and the second frequency band being separated by a third frequency band; and
providing at least a first half-duplex frequency division duplex (H-FDD) channel operating within the third frequency band, a transmission of the first H-FDD channel being synchronized with one of a an uplink transmission or a downlink transmission of the TDD channel;
the first FDD channel, the first TDD channel, and the first H-FDD channel being collocated with one another.

8. The method of claim 7, further comprising providing a second FDD channel operating within a fourth frequency band, the fourth frequency band separated from the second frequency band by a fifth frequency band, and providing a second H-FDD channel operating within the fifth frequency band.

9. The method of claim 8, wherein the first FDD channel includes an FDD wireless uplink channel and the second FDD channel includes a FDD wireless downlink channel.

10. The method of claim 8, wherein the first H-FDD channel includes an H-FDD wireless uplink channel and the second H-FDD channel includes an H-FDD wireless downlink channel.

11. The method of claim 7, wherein the first H-FDD channel includes a wireless uplink channel, the method further including synchronizing the uplink transmission of the first TDD channel and the transmission of the first H-FDD channel.

12. The method of claim 7, wherein the first H-FDD channel includes a wireless downlink channel, the method further including synchronizing the downlink transmission of the TDD channel and the transmission of the first H-FDD channel.

13. A method for implementing a time division duplex (TDD) wireless system in a wireless network including a frequency division duplex (FDD) wireless system, the method comprising:
replacing a first frequency band of a the FDD wireless system with at least a first TDD wireless channel, including leaving a first and a second guard band separating the first TDD wireless channel and at least a first and a second adjacent FDD wireless channel;
deploying a half-duplex frequency division duplex (H-FDD) system in the first and second guard bands.

14. The method of claim 13, wherein replacing the first frequency band of the FDD wireless system includes replacing the first frequency band with at least one H-FDD wireless channel of the H-FDD system, and replacing at least a portion of the at least one H-FDD wireless channel with at least the first TDD wireless channel, wherein the H-FDD system is deployed in the first and second guard bands.

15. The method of claim 13, further including expanding the TDD wireless channel to eliminate the first and second FDD wireless channels.

16. The method of claim 13, wherein the first FDD wireless channel includes an uplink channel, and the H-FDD system deployed in the first guard band includes an uplink channel adjacent to the first FDD wireless channel, and the second FDD wireless channel includes a downlink channel, and the H-FDD system deployed in the second guard band includes a downlink channel adjacent to the second FDD wireless channel.

17. The method of claim 13, wherein the H-FDD system includes an H-FDD uplink channel, transmission of the H-FDD uplink channel being synchronized with an uplink transmission of the first TDD wireless channel.

18. The method of claim 13, wherein the H-FDD system includes an H-FDD downlink channel, transmission of the H-FDD downlink channel being synchronized with a downlink transmission of the first TDD wireless channel.

19. A wireless system comprising:
a half-duplex frequency division duplex (H-FDD) system configured to provide at least a first H-FDD channel, a transmission of the first H-FDD channel being configured to be synchronized with one of an uplink transmission or a downlink transmission of a TDD channel of a TDD wireless system.

20. The wireless system of claim 19, wherein the first H-FDD channel is an uplink channel, and the transmission of the first H-FDD channel is configured to be synchronized with the uplink transmission of the TDD wireless system.

21. The wireless system of claim 19, wherein the first H-FDD channel is a downlink channel, and the transmission of the first H-FDD channel is configured to be synchronized with the downlink transmission of the TDD wireless system.
